(19) United States
(12) Patent Application Publication
(10) Pub. No.: US 2009/0033233 A1
(43) Pub. Date: Feb. 5, 2009

(54) Plasma display and its driver and driving method thereof

(76) Inventor: Seong-Joong Kim, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/219,440

(22) Filed: Jul. 22, 2008

(30) Foreign Application Priority Data
Aug. 2, 2007 (KR) 10-2007-0077383

(51) Int. Cl. G09G 3/10

(52) U.S. Cl. 315/169.4

(57) ABSTRACT

A plasma display includes an electrode, a first switch, a second switch, a third switch, an inductor, and a diode. The first switch is coupled to the electrode. The second switch is coupled between the electrode and a first power source to supply a first voltage. The third switch is coupled between the electrode and a second power source to supply a second voltage. The inductor is coupled between a second terminal of the first switch and a third power source to supply a third voltage. The diode is coupled in parallel with the inductor. The first switch includes a first and second transistors coupled in series, the first and second transistors being coupled back-to-back.

### CLAIM OF PRIORITY

This application makes reference to, incorporates the same herein, and claims all benefits accruing under 35 U.S.C. §119 from an application earlier filed in the Korean Intellectual Property Office on the 2 Aug. 2007 and there duly assigned Serial No. 10-2007-0077383.

### BACKGROUND OF THE INVENTION

1. Field of the Invention

The present invention relates to a plasma display and a driving apparatus and driving method thereof.

2. Description of the Related Art

A plasma display includes a Plasma Display Panel (PDP) that uses plasma generated by a gas discharge to display characters or images.

One frame of such a plasma display is divided into a plurality of subfields having weight values. During a sustain period of each subfield, a sustain pulse is supplied to electrodes forming a discharge cell, and a display operation is performed.

During the time that the sustain pulse is supplied to electrodes, a current may flow to a power source through a parasitic component of a switch coupled between the electrodes and the power source for supplying a predetermined voltage. Accordingly, a voltage variation may occur in the power source, and the voltage may not be stably supplied.

### SUMMARY OF THE INVENTION

The present invention has been made in an effort to provide a plasma display for stably supplying a voltage to an electrode, a driving apparatus and a driving method thereof.

An exemplary plasma display according to an embodiment of the present invention includes an electrode, a first switch, a second switch, a third switch, an inductor, and a diode. The first switch is coupled to the electrode. The second switch is coupled between the electrode and a first power source to supply a first voltage. The third switch is coupled between the electrode II and a second power source to supply a second voltage. The inductor is coupled between a second terminal of the first switch and a third power source to supply a third voltage. The diode is coupled in parallel with the inductor.

An exemplary driver according to another embodiment of the present invention drives a plasma display including a plurality of first electrodes and a plurality of second electrodes to together perform a display operation. The driver includes a switch, an inductor, a diode, and a sustain driver. The switch is coupled to the plurality of first electrodes. The inductor is coupled between the switch and a first power source to supply a first voltage. The diode is coupled in parallel with the inductor. The sustain driver is coupled to the plurality of first electrodes, and alternately supplies a second voltage that is higher than the first voltage and a third voltage that is lower than the first voltage to the plurality of first electrodes during a sustain period.

In an exemplary method for driving a plasma display including a plurality of electrodes, a first voltage is supplied to the plurality of electrodes through an inductor during an address period, a second voltage and a third voltage that is lower than the second voltage are alternately supplied to the plurality of electrodes during a sustain period, and a voltage generated in the inductor is transmitted to a power source to supply the first voltage through a diode coupled in parallel with the inductor.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicated the same or similar components, wherein:

FIG. 1 is a block diagram of a plasma display according to an exemplary embodiment of the present invention.

FIG. 2 is a circuit diagram of a driving circuit of a sustain electrode driver according to a first exemplary embodiment of the present invention.

FIG. 3 is a waveform diagram of a driving waveform of the plasma display according to the exemplary embodiment of the present invention.

FIG. 4 is a circuit diagram of a driving circuit of the sustain electrode driver according to a second exemplary embodiment of the present invention.

### DETAILED DESCRIPTION OF THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising”, will be understood to imply the inclusion of stated elements but not the exclusion of any other elements.

When it is described in the specification that a voltage is maintained, it should not be understood to strictly imply that the voltage is maintained exactly at a predetermined voltage. To the contrary, even if a voltage difference between two points varies, the voltage difference is expressed to be maintained at a predetermined voltage in the case that the variance is within a range allowed in design constraints or in the case that the variance is caused due to a parasitic component that is usually disregarded by a person of ordinary skill in the art. In addition, since threshold voltages of semiconductor elements (e.g., a transistor and a diode) are very low compared to a discharge voltage, they are considered to be 0V.

A plasma display according to an exemplary embodiment of the present invention, a driving apparatus and driving method thereof is described below with reference to the figures.

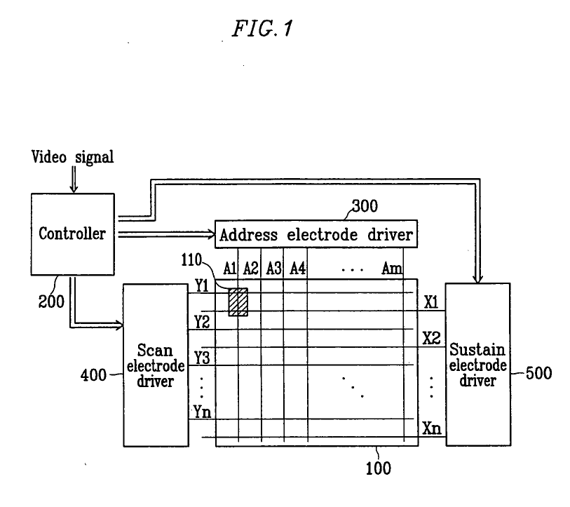

As shown in FIG. 1, the plasma display according to the exemplary embodiment of the present invention includes a Plasma Display Panel (PDP) 100, a controller 200, an address electrode driver 300, a scan electrode driver 400, and a sustain electrode driver 500.

The PDP 100 includes a plurality of address electrodes Al to Am (hereinafter, referred to as “A electrodes”) extending in a column direction, and a plurality of sustain and scan electrodes X1 to Xn and Y1 to Yn (hereinafter, referred to as “X and Y electrodes”) in pairs extending in a row direction. The X electrodes X1 to Xn are formed in correspondence with the Y electrodes, and a display operation is performed by the X and Y electrodes during the sustain period. The Y and X electrodes Y1 to Yn and X1 to Xn are arranged perpendicular to the A electrodes A1 to Am. A discharge space formed in an area where the A electrodes A1 to Am cross the X and Y electrodes X1 to Xn and Y1 to Yn forms a discharge cell (hereinafter, referred to as a “cell”) 110. The configuration of the PDP 100 of FIG. 1 is an example, and other exemplary configurations may be supplied in the present invention.

The controller 200 outputs X, Y, and A electrode driving control signals after receiving an external video signal. In addition, the controller 200 operates on each frame divided into a plurality of subfields having respective weight values, and each subfield includes a reset period, an address period, and a sustain period.

After receiving the A electrode driving control signal from the controller 200, the address electrode driver 300 supplies display data signals for selecting discharge cells to be displayed to the respective address electrodes A1-Am.

The scan electrode driver 400 supplies a driving voltage to the Y electrode after receiving the Y electrode driving control signal from the controller 200, and the sustain electrode driver 500 supplies a driving voltage to the X electrodes X1 to Xn after receiving the X electrode driving control signal from the controller 200.

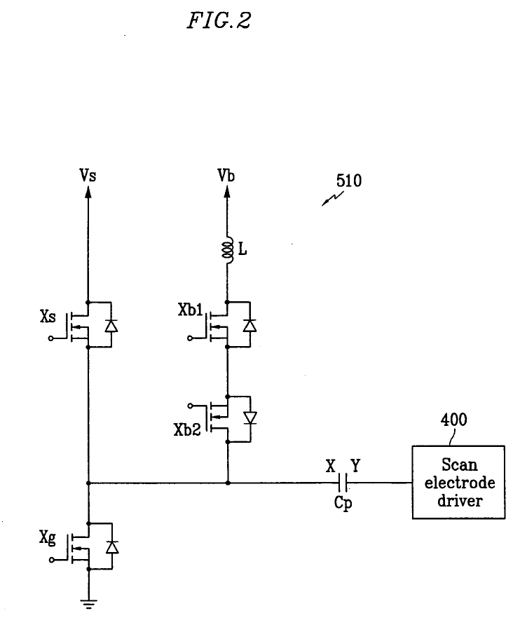

A driving circuit of the plasma display according to a first exemplary embodiment of the present invention is described below with reference to FIG. 2.

FIG. 2 is a circuit diagram of a driving circuit 510 of the sustain electrode driver 500 according to the first exemplary embodiment of the present invention. For better understanding and ease of description, the driving circuit 510 is coupled only to the plurality of X electrodes X1 to Xn in FIG. 2, and a driving circuit 410 may also be coupled to the plurality of Y electrodes Y1 to Yn. The driving circuit 510 may be contained within the sustain electrode driver 500 of FIG. 1. In addition, a capacitance formed by the X and Y electrodes X and Y is represented by a panel capacitor Cp.

As shown in FIG. 2, the driving circuit 510 includes transistors Xs, Xg, Xb1, and Xb2 and an inductor L. In FIG. 2, the respective transistors are illustrated as n-channel Field Effect Transistors (FETs), particularly, n-channel Metal Oxide Semiconductor (NMOS) FETs. However, other transistors having same or similar functions may be used. In addition, the transistors Xs, Xg, Xb1, and Xb2 are respectively illustrated as single transistors in FIG. 2. However, they are not limited thereto, and the transistors may be formed by a plurality of transistors coupled in parallel.

Referring to FIG. 2, a source of the transistor Xs and a drain of the transistor Xg are coupled to the X electrode, a drain of the transistor Xs is coupled to a power source Vs for supplying a Vs voltage, and a source of the transistor Xg is coupled to a ground terminal 0V. A drain of the transistor Xb2 is coupled to the X electrode and a node of the transistor Xs and the transistor Xg, a source of the transistor Xb2 is coupled to a source of the transistor Xb1, and a drain of the transistor Xb1 is coupled to a first terminal of the inductor L. That is, the two transistors Xb1 and Xb2 are coupled in a back-to-back manner. A second terminal of the inductor L is coupled to a power source Vb for supplying a Vb voltage.

Rather than using the transistors Xb1 and Xb2 coupled in the back-to-back manner in FIG. 2, a single transistor may be used as a switch for supplying the Vb voltage to the X electrode. In addition, rather than using the transistor Xb2 to interrupt a current path caused by a body diode of the transistor Xb1, a diode may be used.

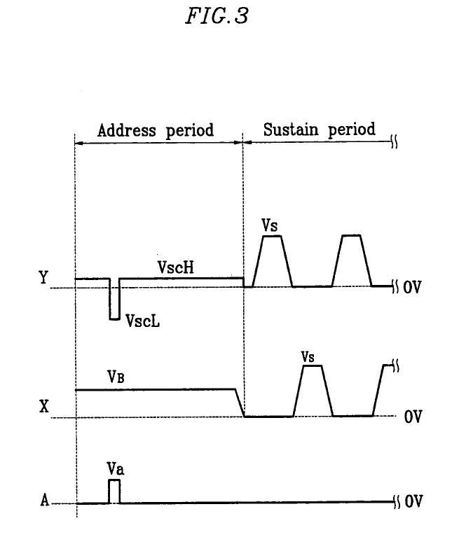

The operation of the driving circuit 510 of FIG. 2 is described below with reference to FIG. 3.

FIG. 3 is a waveform diagram representing a driving waveform of the plasma display according to the exemplary embodiment of the present invention. For better understanding and ease of description, the address and sustain periods in only one subfield are illustrated in FIG. 3.

As shown in FIG. 2 and FIG. 3, during the address period, the transistors Xb1 and Xb2 are turned on, the Vb voltage is supplied to the X electrode, and a scan pulse having a VscL voltage is sequentially supplied to the plurality of T electrodes in order to select a cell to be turned on. In this case, a Va voltage is supplied to the A electrode passing a cell in which an address discharge is generated among a plurality of cells defined by the Y electrode receiving the VscL voltage and the X electrode. In the exemplary embodiment of the present invention, the cell in which the address discharge is generated may be selected as a turned-on cell (i.e., a cell to be turned on). In another exemplary embodiment of the present invention, the cell in which the address discharge is generated may be selected as a turned-off cell (i.e., a cell to be turned off). A VscH voltage that is higher than the VscL voltage is supplied to the Y electrode to the Y electrode to which the VscL voltage is not supplied, and 0V voltage is supplied to the A electrode of an unselected cell.

During the sustain period, a sustain pulse having the Vs voltage is alternately supplied to the Y electrode and the X electrode, and the 0V voltage is supplied to when the sustain pulse is not supplied to the X and Y electrodes. A sustain discharge is then generated between the X and Y electrodes of the turned-on cell.

In this case, since the transistor Xs coupled to the power source Vs and the transistor Xg coupled to the ground terminal are alternately turned on while the transistors Xb1 and Xb2 are turned off, the sustain pulse having the Vs voltage and the 0V is alternately supplied to the X electrode. Subsequently, the sustain pulse is repeatedly supplied to the X and Y electrodes a predetermined number of times that corresponds to a weight of the corresponding subfield.

When the sustain pulse is repeatedly supplied to the X electrode while the transistors Xb1 and Xb2 are turned on, currents may flow to the transistors Xb1 and Xb2 through a parasitic capacitance component formed in the transistor Xb2 and the body diode of the transistor Xb1. In this case, when the inductor L is not provided, the current may flow to the power source Vb. A voltage at the power source Vb can vary, and the Vb voltage may not be properly supplied to the X electrode during the address period of a subsequent subfield. However, when the inductor L is provided as in the first exemplary embodiment of the present invention, since the inductor L functions as a impedance component when the sustain pulse repeatedly varies, a voltage variation of the power source Vb may be reduced.

However, when the transistors Xb1 and Xb2 are turned off after turned on, a counter electromotive force can occur. A high voltage may be supplied to the transistors Xb1 and Xb2 by the counter electromotive force.

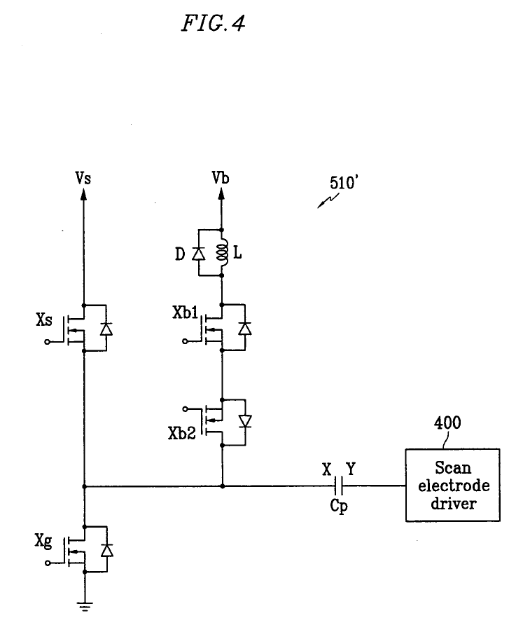

A method for reducing the voltage supplied to the transistors Xb1 and Xb2 is described below with reference to FIG. 4.

FIG. 4 is a circuit diagram of a driving circuit 510′ of the sustain electrode driver 500 according to a second exemplary embodiment of the present invention.

As shown in FIG. 4, an anode of a diode D is coupled to the first terminal of the inductor L and a cathode of the diode D is coupled to the second terminal of the inductor L. That is, the driving circuit 510′ according to the second exemplary of the present invention is the same as that of the first exemplary embodiment of the present invention except that the diode D is coupled to the inductor L in parallel.

During the time that the transistors Xb1 and Xb2 are turned off, when a voltage at the first terminal of the inductor L is increased to a voltage that is higher than the Vb voltage by the counter electromotive force, the diode D has a forward direction characteristic, and the diode D transmits a voltage formed in the inductor L to the power source Vb. Accordingly, the transistors Xb1 and Xb2 having a voltage that is lower than that of the first exemplary embodiment of the present invention may be used.

While this invention has been described in connection with what is presently considered to be practical exemplary embodiments, it is to be understood that the present invention is not limited to the disclosed embodiments, but, on the contrary, is intended to cover various modifications and equivalent arrangements included within the spirit and scope of the appended claims.

According to the exemplary embodiment of the present invention, since the diode is formed in parallel with the inductor in the driving circuit for driving the sustain electrode, the counter electromotive force is eliminated, and the voltage at a transistor may be reduced.

What is claimed is:

1. A plasma display comprising:
an electrode;
a first switch coupled to the electrode;
a second switch, coupled between the electrode and a first power source, to supply a first voltage;
a third switch, coupled between the electrode and a second power source, to supply a second voltage;
an inductor, coupled between a second terminal of the first switch and a third power source, to supply a third voltage; and
a diode coupled in parallel with the inductor.

2. The plasma display of claim 1, wherein the first switch comprises a first transistor and a second transistor coupled in series, the first and second transistors being coupled back-to-back.

3. The plasma display of claim 1, wherein the first switch is turned on during an address period.

4. The plasma display of claim 1, wherein a cathode of the diode is coupled to the third power source, and an anode thereof is coupled to the second terminal of the first switch.

5. The plasma display of claim 1, wherein the second and third switches are alternately turned on during a sustain period.

6. A driver for driving a plasma display including a plurality of first electrodes and a plurality of second electrodes to together perform a display operation, the driver comprising:
a switch coupled to the plurality of first electrodes;
an inductor, coupled between the switch and a first power source, to supply a first voltage;
a diode coupled in parallel with the inductor; and
a sustain driver coupled to the plurality of first electrodes, the sustain driver alternately supplying a second voltage that is higher than the first voltage and a third voltage that is lower than the first voltage to the plurality of first electrodes during a sustain period.

7. The driver of claim 6, wherein the switch comprises a first transistor and a second transistor coupled in series, the first and second transistors being coupled back-to-back.

8. The driver of claim 6, wherein the switch is turned on during an address period.

9. A method of driving a plasma display including a plurality of electrodes, the method comprising:
supplying a first voltage to the plurality of electrodes through an inductor during an address period;
alternately supplying a second voltage and a third voltage that is lower than the second voltage to the plurality of electrodes during a sustain period; and
transmitting a voltage generated in the inductor to a power source to supply the first voltage through a diode coupled in parallel with the inductor.
